(19) United States
(12) Patent Application Publication
(10) Pub. No.: US 2011/0016008 A1
(43) Pub. Date: Jan. 20, 2011

(54) Electronic registration systems for processing variable or multiple return/warranty policies, and associated methods

(75) Inventors: Maridee Joy Maraz, Sammamish, WA (US); Dustin Ares, Woodinville, WA (US)

Correspondence Address: NIXON & VANDERHYE, P.C., 901 NORTH GLEBE ROAD, 11TH FLOOR, ARLINGTON, VA, 22203, US

(73) Assignee: Nintendo of America Inc.,, Redmond, WA (US)

(21) Appl. No.: 12/801,810

(22) Filed: Jun. 25, 2010

Related U.S. Application Data
(60) Provisional application No. 61/213,779, filed on Jul. 14, 2009.

(51) Int. Cl. G06Q 30/00; G06Q 10/00

(52) U.S. Cl. 705/21; 705/302

(57) ABSTRACT

The exemplary embodiments described herein relate to the field of electronic registration (ER) of purchased products and, more particularly, to an improved electronic registration system that enables variable or multiple return/warranty policies to be processed. In certain exemplary embodiments, at least some transaction information corresponding to an originally purchased product is selectively provided to replacement products provided as a part of a return/warranty request. Thus, it is possible in certain exemplary embodiments to make sure that a return/warranty policy's terms and/or conditions are managed consistently and effectively, even though one or more replacement products may be provided during the lifetime of the policy. In an example variable policy, no refunds are available past a first time period, no exchanges are available past a second time period, and only pro-rata exchanges are available in a third time period, with the periods being fixed regardless of how many times a product has been replaced.

### CROSS-REFERENCE TO RELATED APPLICATIONS

This application claims the benefit of U.S. Application No. 61/213,779, filed Jul. 14, 2009, the entire contents of which is incorporated herein in its entirety by reference.

### TECHNICAL FIELD

The exemplary embodiments described herein relate to the field of electronic registration (ER) of purchased products and, more particularly, to an improved electronic registration system that enables variable or multiple return/warranty policies to be processed. In certain exemplary embodiments, at least some transaction information corresponding to an originally purchased product may be selectively provided to replacement products provided as a part of a return/warranty request. Thus, it is possible in certain exemplary embodiments to make sure that a return/warranty policy's terms and/or conditions are managed consistently and effectively, even though one or more replacement products may be provided during the lifetime of the policy.

### BACKGROUND AND SUMMARY

Electronic registration (ER) of product transactions recently has become available for the purpose of reducing unauthorized returns of purchased products and/or unauthorized warranty repair on purchased products. Electronic product registrations systems provided for this purpose are disclosed in, for example, U.S. Pat. Nos. 5,978,774; 6,018,719; and 6,085,172, the disclosures of which are all incorporated by reference herein in their entirety. The electronic registration system relies on the use of a unique identifier, such as a serial number linked to a UPC (and/or RFID) or its equivalent, for each product that is purchased. The serial number is obtained at the point of sale for inclusion in a registration database, together with other information, such as a date of transaction. This database can then be accessed in connection with an attempted product return/warranty transaction for the purpose of determining if the product qualifies for return/warranty under applicable return/warranty criteria under which the product was originally sold. Such electronic systems may also be used in connection with repair and/or exchange transactions, in addition to returns, by enabling an accurate determination as to whether the product qualifies for any of these actions under the appropriate policies and criteria under which the product was originally sold.

The ER system uses pre-established return/repair policies and procedures that are programmed into the ER system so that the system can perform a check when a product is presented for return to determine if the product qualifies for return, replacement and/or warranty repair based on sales transaction information available in the ER system for the particular product at issue. Thus, known ER systems include a database of return qualification information (or warranty/replacement criteria) for various manufacturers and/or retailers which enables the system to make an accurate determination with respect to whether or not a product actually qualifies for return (or warranty/replacement) based on the appropriate criteria and at the time the product is actually presented for return. Such ER systems have greatly reduced improper and fraudulent returns and warranty claims.

While such ER systems have proven to be very useful in their current forms, additional improvements in the system are still desired to make such ER systems more flexible in operation in order to benefit customers, retailers, and manufacturers. For example, items such as batteries used in automobiles, motorcycles, boats and lawn, and garden products often are sold with variable or multiple return and warranty terms and conditions. Such variable or multiple return and warranty terms and conditions sometimes specify that a purchaser may be eligible for a refund or exchange during a first time period (e.g., 90 days), an exchange only during a second time period (e.g., from 91 days to 1 year), and a pro-rata return during a third time period (e.g., from one year and one day to three, five, or seven years). When an item is exchanged during the first or second time period, in certain instances, the time periods for return, exchange, and pro-rata return are to remain the same. It will be appreciated that a significant “history” of returns and/or exchanges may develop if a customer receives one or more “duds” in a row. Regardless of the number of returns, exchanges, and the like—and thus the number of replacement items—the originally defined time periods are to remain the same in such cases.

Although it is possible to use ER systems to define original and/or customized return/warranty policies to track individual items, further improvements could be made to current ER systems so that this sort of history is maintained throughout the return, exchange, and pro-rata return periods for the original product sale. Currently, a consumer may purchase a battery once and exchange it multiple times with no out-of-pocket cost. But with each exchange, the return policy and warranty terms may inappropriately begin anew (as in the above example, when products are repeatedly returned in the pro-rata period). Unfortunately, this inability to accurately and consistently manage variable or multiple return and warranty programs drives up the costs of the retailer and/or manufacturer administering the program.

Thus, it will be appreciated that there is a need in the art for improved ER techniques that provide a systematized approach to tracking return eligibility based on the point-of-sale date of each item, particularly in instances where items are sold with multiple or variable warranty terms and conditions. It also will be appreciated that there is a need in the art for ER techniques that help manage these multiple or variable programs, while also attaching the correct “carry over” warranty terms and/or conditions for the replacement(s) product(s). Further, it will be appreciated that support for both receipted and non-receipted returns and/or exchanges in connection with such programs also would desirable.

One aspect of certain exemplary embodiments relates to the ability to improve and add efficiency to the tracking of products throughout variable return and warranty periods. In this regard, certain exemplary embodiments involve a technique to electronically capture serial numbers and maintain visibility of items from manufacturer to point-of-sale (POS), and throughout the return and warranty periods. It will be appreciated that such techniques are beneficial in enforcing, for example, exchange and pro-rata battery return scenarios.

Another aspect of certain exemplary embodiments relate to the enhanced tracking in collaboration and compliance with a POS location's store return policy, and for refunds and exchanges under the further warranty programs. For example, certain exemplary embodiments help a POS location manage the returns and warranty program for every product sold, returned, or exchanged for the 1, 2, or 3 year replacement warranty eligibility periods and for the 5, 6, or 9 year pro-rata eligibility periods. Certain exemplary embodiments and track the eligibility for exchanged units from the replacement warranty period based on the initial item's purchase date, upon which the terms and conditions of the sale are based.

According to certain exemplary embodiments, a method of processing a product at a point-of-sale (POS) location is provided. The product is identified at the POS location. Return/warranty information is retrieved from an electronic registration (ER) database, with the return/warranty information indicating a first time period during which a refund is acceptable, a second time period during which product replacement is acceptable, and a third time period during which pro-rata product exchange is acceptable. It is determined whether the processing is taking place during the first, second, or third time period. When the processing is taking place during the first time period, the refund or a replacement product is provided. When the processing is taking place during the second time period, a replacement product is provided. When the processing is taking place during the third time period, an amount of credit for the subsequent purchase of a replacement product is provided, with the amount of credit being relative to when the processing is taking place in the third time period. When the processing is taking place beyond the third time period, any return/warranty request is denied. The ER database is updated to reflect a refund, replacement product, or pro-rata exchange. When a replacement product is provided, at least some information pertaining to the product is associated with the replacement product in the ER database. In certain exemplary embodiments, the ER system may determine the time period and applicable terms and conditions, and the POS location may optionally execute based on this information. In certain exemplary embodiments, the ER system may execute based on the information. In certain exemplary embodiments, the ER system may be located remote from the POS location, whereas it may be co-located with the POS location in different exemplary embodiments.

According to certain exemplary embodiments, a method of managing an electronic registration (ER) system including an ER database is provided. The ER database is populated with information corresponding to a plurality of products. The ER database is updated as products are sold, and the ER database includes a unique identifier for the product and an original transaction date corresponding to the sale. An already-purchased product presented for return or exchange at a point-of-sale (POS) location is identified. Terms and/or conditions for the return or exchange are determined based on the original transaction date stored in the ER database and associated with the product. A refund or replacement product is provided when doing so is acceptable within the terms and/or conditions. When a replacement product is provided, the ER database is updated so that an original transaction date for the replacement product corresponds to the original transaction date for the already-purchased product for at least some of the terms and/or conditions.

According to certain exemplary embodiments, an electronic registration (ER) system is provided. An ER database includes information corresponding to a plurality of products, with the ER database being updated by the ER system as products are sold to reflect an original transaction date corresponding to the sale. A return validation subsystem is configured to: (1) identify an already-purchased product presented for return or exchange at a point-of-sale (POS) location; (2) determine terms and/or conditions for the return or exchange based on the original transaction date stored in the ER database and associated with the product; (3) send a message to the POS location authorizing a refund or replacement product to be provided when doing so is acceptable within the terms and/or conditions; and (4) when a replacement product is provided, update the ER database so that an original transaction date for the replacement product corresponds to the original transaction date for the already-purchased product for at least some of the terms and/or conditions.

It will be appreciated that these aspects and embodiments may be combined in various combinations and sub-combinations to achieve yet further exemplary embodiments. Also, it will be appreciated that the exemplary embodiments herein may be implemented as any suitable combination of programmed logic circuitry including, for example, hardware, software, firmware, etc.

### BRIEF DESCRIPTION OF THE DRAWINGS

These and other features and advantages will be better and more completely understood by referring to the following detailed of exemplary illustrative non-limiting implementations in conjunction with the drawings, of which:

FIG. 1 is a schematic block diagram illustrating an example of an overall electronic product registration (ER) system that may be used in accordance with an exemplary embodiment;

FIG. 2 is a high level flow chart of some of the main steps performed in accordance with prior electronic product registration (ER) systems;

FIG. 3 shows one example serialization/mask that may be used in connection with certain exemplary embodiments;

FIG. 4 is a visual timeline of an illustrative return/warranty policy in accordance with certain exemplary embodiments;

FIG. 5 is an illustrative, high-level flow for handling multiple or variable return/warranty policies in accordance with certain exemplary embodiments;

FIG. 6 is a detailed view of the return policy flow in accordance with certain exemplary embodiments;

FIG. 7 is a detailed view of the exchange policy flow in accordance with certain exemplary embodiments;

FIG. 8 is an illustrate message indicating that a product being returned is within the replacement warranty period, in accordance with certain exemplary embodiments;

FIG. 9 is an illustrate message indicating that a purchase record could not be found, in accordance with certain exemplary embodiments;

FIGS. 10 and 11 are messages indicating that the item presented for the return/warranty request only quality for replacement and pro-rata exchange, respectively, in accordance with certain exemplary embodiments;

FIG. 12 is an illustrative message including detail on all phases of the return/warranty program, in accordance with certain exemplary embodiments;

FIG. 13 is an illustrative message indicating that a product qualifies for one of several return/warranty policies and provides a specific value for a pro-rata exchange, in accordance with certain exemplary embodiments; and

FIG. 14 is an illustrative message for a product that has been flagged as being returned and/or exchanged too many times, in accordance with certain exemplary embodiments.

### DETAILED DESCRIPTION

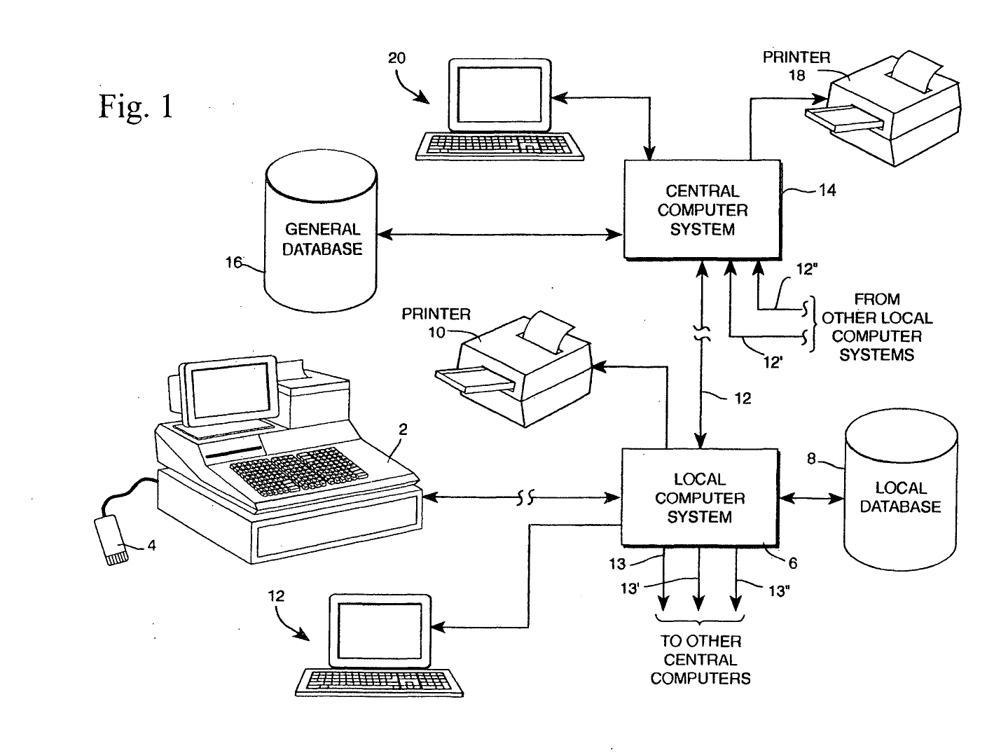

An example of one type of electronic product registration (ER) system that is preferably used in connection with the instant invention is illustrated in FIG. 1. Briefly, this example system includes a point of sale register 2 and an associated bar code scanner 4. The register 2 is preferably connected with a local computer system 6 in any suitable manner. In certain situations (e.g., single store retailers), it may be advantageous to have the local computer system 6 located in proximity to the register 2. For large chain stores, however, it may be advantageous to situate the local retailer computer 6 at a central location with links to the registers 2 at individual stores. The particular arrangement will depend on the preferences and circumstances of the specific retailer and may vary in accordance therewith.

The local retailer computer system includes an associated local database 8 for storing registration information. Additionally, a local printer 10 and an operator terminal 11 may be provided. The operator terminal may be used, for example, by a store clerk upon return of merchandise to locate pertinent sales information in the local database 8. The printer 10 may be used to produce hard copies of, for example, end-of-day sales reports and/or the like.

In the exemplary embodiment, a communication channel 12 is provided between the retailer computer system 6 and a central computer system 14. The central registration computer system may, for example, be an independent registration center computer system which electronically registers product transactions for a number of different retailers. In other words, the central computer system may be operated by a third-party service provider.

A general registration database 16 is associated with the central registration computer system 14 for storing transaction information from a plurality of retailer computer systems 6. Additionally, a printer 18 and an operator terminal 20 may be included with the central registration computer system 14. As discussed below in greater detail, the central registration computer system may maintain a number of data files pertaining to individual retailers, manufactures and the like. These data files include information applicable to the particular individual retailer, distributor, manufacturer or the like and are preferably maintained by that particular individual or entity. For example, a data file may contain specific return/warranty policy information applicable to that particular individual or entity.

It should be appreciated that the central computer system 14 is preferably intended to handle product registrations for a number of different manufacturers and/or other vendors. Accordingly, the general registration database may employ a structure wherein the product registrations for each participating vendor is maintained in separate areas. Alternatively, separate databases may be employed for each participating vendor. Of course, other data structures may be employed so long as the registration center is able to properly keep track of the product transaction information and particular return and/or warranty policies associated with each transaction.

As illustrated in FIG. 1, the central registration computer system 14 may have a number of additional communications links 12′, 12″, etc. for receiving information from other local computer systems. Thus, for example, a registration center may receive information from a number of different retailers. Additionally, the local computer system 6 may include a number of additional communication channels 13, 13′, 13″, etc. for connecting with other central computer systems. Accordingly, an individual retailer can electronically register products with a number of different registration databases, if desired. Furthermore, a number of communication channels 15, 15′, 15″, etc. can be provided for communications between the central registration computer system 14 and individual manufacturer computer systems and computer systems of third party service providers, law enforcement agencies and/or the like. Of course, a general access channel such as an Internet connection may also be made available for authorized access to the central computer system 14.

The electronic registration process begins when a customer brings merchandise to the register 2 for check-out. The sales clerk enters the SKU number which identifies the type of product involved in the transaction (e.g., Super Nintendo Entertainment System, Nintendo Game Boy, Nintendo N64, etc.) by, for example, scanning a UPC product code included on the product packaging. Of course, key entry or another technique for entering the SKU number may be used. Electronic registration might not be necessary for a substantial number of small commodity products (e.g., batteries, candy, diapers, etc.) that are commonly sold by retailers. Accordingly, a check may be made, based on the type of product as identified by the UPC code, to determine whether this is a product for which electronic registration is desired. If so, the store associate is prompted to enter the serial number of the individual item.

The serial number may be entered, for example, by scanning a serial number printed on the packaging. Alternatively, the serial number as it appears on the product may be scanned through a window in the packaging. This alternative ensures that the individual product is identified even if it is mispackaged. Also, repackaging of returned merchandise would be simplified. Other techniques, such as key entry, may also be used. Because the serial number is unique to each individual product, it acts as individual production identification information.

Once the serial number is entered, a check may be made to ensure that the serial number is valid. If not, the store associate is again prompted to enter the serial number. This is repeated until a valid serial number is obtained. Once the serial number is verified, a local database may be updated with the serial number information and any other necessary or desired information. At minimum, however, the local database should include an indication of the date on which the transaction took place. Other information might include the price paid, the store associate responsible for the sale, and the like.

The serial number of the individual product is preferable printed as part of a written customer transaction receipt. The serial number may be printed adjacent the description and SKU number of the registered product. Thus, it will be a simple matter to correlate serial numbers with associated products, particularly when several registered products appear on a single customer sales receipt. Of course, additional information may be printed as well.

The date of the transaction will typically be printed at either the beginning or the end of the sales receipt, but may appear anywhere on the receipt. After the serial number is printed, a check is made to determine whether sales are complete. Ordinarily, this will be based on the store associate hitting a TOTAL button on the cash register. Thereafter, the central registration computer system 14 is contacted and the general registration database 16 is updated with the transaction information.

Inasmuch as ER systems are known, further specific details regarding ER systems themselves will not be provided herein except as needed for a complete understanding of the invention. As seen from the above description of an ER system, original policies are defined for products when they are first sent to the retailer by the vendor. The ER system preferably includes the policies of both the vendor and the retailer and enables the policies of both parties to be easily and conveniently enforced.

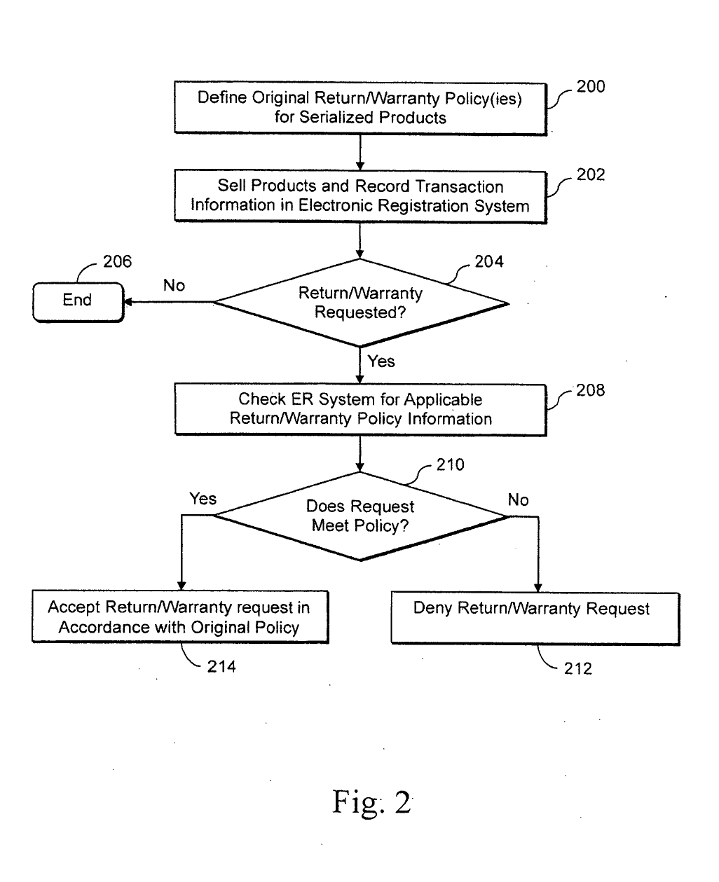

FIG. 2 shows the main steps performed in connection with conventional ER systems. As shown in FIG. 2, the return/warranty policy(ies) are defined for serialized products and entered into the ER system (step 200). The ER system uses the policies and the sales transaction information, as well as the date on which a return is requested, to determine if the product qualifies for return when presented for return. Thus, when the products are sold, the sales transaction is recorded in the ER database (step 202). If the consumer is satisfied with the product, then the process ends (step 206). On the other hand, if a return is requested (step 204), the ER system is accessed to obtain the return qualification information for the specific product being presented for return (step 208). In accordance with conventional ER systems, the return request is handled based on the return qualification information provided by the ER system based on the original policies under which the product was originally sold. Thus, based on the return qualification information provided by the ER system, a determination is made as to whether or not the product qualifies for return/warranty repair or the like (step 210). If the product does qualify for the action requested, the request can be honored by the retailer and the transaction can be completed (step 214). On the other hand, if the ER system indicates that the product does not qualify for the requested action, the customer is typically denied the return or warranty repair (step 212). Of course, the store clerk could decide, for some reason, to ignore the ER information and accept the product anyway.

As indicated above, items such as batteries used in automobiles, motorcycles, boats and lawn, and garden products often are sold with variable or multiple return and warranty terms and conditions. As an example, batteries may be sold with a 90-day Return Policy (where the consumer will receive a refund for the battery), a 1-year Replacement Warranty (where the consumer will be able to exchange the product at no additional fee), and a 3-year Pro-Rated Warranty (where the consumer will receive an adjusted refund amount used as a credit towards the purchase of a new battery). To solve the above-described and/or other problems, e.g., relating to the current inability to accurately and consistently manage variable or multiple return and warranty programs which drives up the costs of the retailer and/or manufacturer administering the program, certain exemplary embodiments selectively attach the remaining, applicable terms from the original item purchase to the replacement item. For instance, in connection with a warranty that specifies a 90-day replacement period, a one year exchange period, and a three year pro-rata exchange period, if a battery is returned on day 364 from the original sale transaction, the item is not eligible for return, but is eligible for the 1-year replacement warranty at no cost to the consumer. The new battery received by the consumer will have a 1-day replacement warranty, and a 2-year pro-rated warranty remaining, per the terms of the original item purchase. It will be appreciated that this advantageously results in a more consistently managed program that reduces the liability and costs of the retailer and/or manufacturer administering the warranty program.

The techniques of certain exemplary embodiments thus are capable of managing return and warranty programs that include multiple or variable policy criteria. As explained in greater detail below, this is enabled by establishing a unique or original sale transaction from which these multiple policy criteria are managed, and reconciling any further sale and/or exchange transactions involving additional unique items by linking any such additional unique items to the “original” serial number, the original serial number being tied to an “original” transaction serial number that drives the return/warranty exchange program. Thus, even though additional unique items received by the customer in exchange transactions will have different UPCs from the original item, any such additional unique items will still be linked to the original transaction serial number and thus will enable the correct return/warranty policy to be referenced in connection with any further consumer return/warranty requests.

Some current products are not uniquely serialized and retailers and manufacturers are unable to consistently, accurately, and/or efficiently manage these programs—especially return and warranty eligibility of such products at the unique item level. Thus, certain exemplary embodiments may serialize products so that they can be used in connection with the variable return/warranty programs described herein. In this regard, in certain exemplary embodiments, each product may have a UPC and serial number as its unique identifier. It will be appreciated, however, that other unique identifiers such as, for example, RFIDs, EPCs, and the like, also may be used in connection with certain exemplary embodiments.

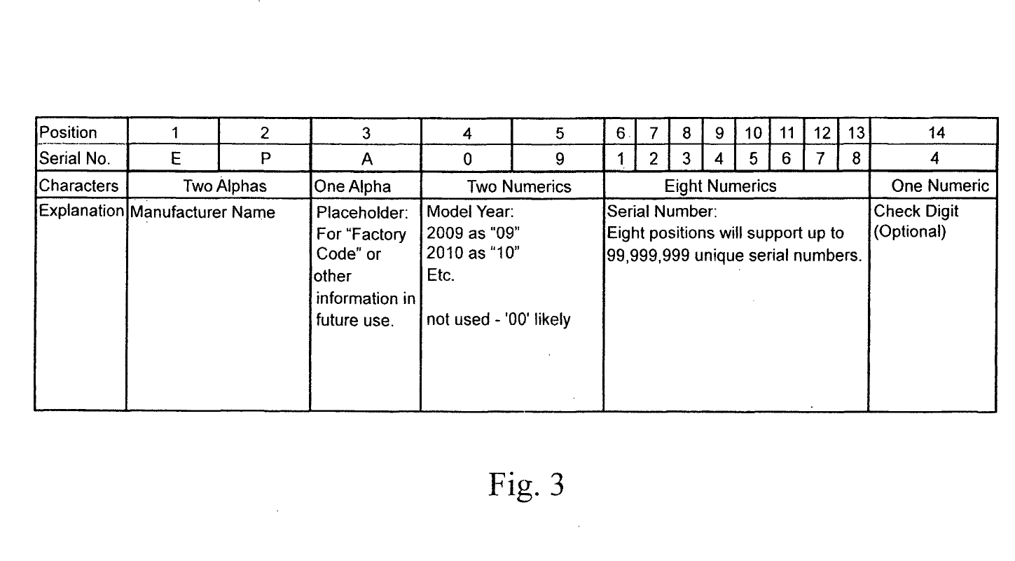

Although any form of serialization or mask can be used, FIG. 3 shows one example serialization/mask that may be used in connection with certain exemplary embodiments. In the FIG. 3 example, a 14 character serial number structure is defined. The first two alpha-characters identify the manufacturer of the product. The next alpha-character may be used as a placeholder, e.g., for a factory code or other information. Two numerical characters may follow, e.g., to identify the model year. The serial number may be expressed as an eight digit number, thereby supporting up to 99,999,999 unique serial numbers. A single numerical character optionally may be provided as a check digit, e.g., using any appropriate algorithm (such as, for example, a predefined algorithm). For instance, in certain exemplary embodiments, a check digit algorithm may be applied to the serial number mask, with the check digit algorithm defining a manner of calculating the check digit of a particular serial number. Furthermore, in certain exemplary embodiments, the check digit algorithm may be defined with six arguments, including starting position, ending position, direction, multiplier, multiplier position, and multiplier reduction. The serial number mask may additionally or alternatively be provided with a plurality of the first characters corresponding to a number of variable digits in the serial number format. See, for example, U.S. Pat. No. 6,947,941 (which is hereby incorporated herein by reference in its entirety) for examples of serial masking and check digit features that may be used in connection with certain exemplary embodiments. Alternatively, this position may be used as a part of the serial number in certain exemplary embodiments, thereby providing support for additional unique serial numbers. Given this description, the serialization may be represented as “wwwxxxxxxxxxxx,” where “w” is an alpha-character and “x” is a numeric character. The serialization may be masked in whole or in part and/or compressed in whole or in part. By using this sort of scheme, it is possible to have multiple manufacturers (e.g., offering different products for sale in the same or different regions, etc.) use a common UPC, while enabling the backend ER system of certain exemplary embodiments to separately track the relevant products. In this regard, the backend ER system of certain exemplary embodiments may differentiate the billable sales amongst the various suppliers, e.g., by using serial number logic, decoding the serial number prefix to determine appropriate billable party, etc. Of course, as noted above, this description represents only a single example serialization/mask that may be used in connection with certain exemplary embodiments, and other serializations may be used in connection with different embodiments of this invention.

In any event, a serial number or other unique identifier is captured at a point-of-sale location. Transaction records are then sent to the ER system for all applicable products sold via the (POS) system. Doing so allows the ER system of certain exemplary embodiments to define the return and warranty start date and to create an electronic sale record that is accessible at any time.

Subsequently, a return or warranty request may be processed. POS systems handling the return or warrant requests are integrated with ER return validation system of certain exemplary embodiments, thus providing for a real-time or substantially real-time validation against a full national database. For each client product presented for return, the POS system may prompt the store associate to scan the item serial number. The scanning may be performed one product at a time, or in batch (e.g., if an RFID is used, if a master serial number is scanned that corresponds to a plurality of individual unique serial numbers, if the serial numbers are at least temporarily stored in a file and the file of serial numbers is transmitted for later processing, etc.). In any event, the scanning of a product or products initiates a query against the ER database and, in connection with the ER database, return and warranty eligibility is validated. In a response that preferably takes less than one second, the ER system provides information to a store associate regarding whether the item is eligible for return or for replacement warranty exchange based on the policy for that unique item.

It will be appreciated that if the unique item already was a replacement product (e.g., the subject of a previous return or pro-rata exchange), at least some of the policy information may be “inherited” from the product being replaced. The same principle also may hold true regardless of whether the product presented at the POS location is a replacement product, a replacement of a replacement product, and so on. That is, in such cases, at least some of the policy information may be “inherited” from the product being replaced such that a full history may be maintained, all the way back to the original product being sold, depending upon the return/warranty policy terms.

Based on this policy information, if an item is within the store return period and thus eligible for a refund, the process is seamless in that a refund for the product simply may be granted. However, if the item is within the replacement warranty exchange period or the pro-rata period, the ER system may stop the return (refund) transaction and provide the warranty information on the POS system, so that the appropriate personnel (e.g., sales clerk, customer service desk staffer, manager on duty, etc.) can assist the customer with the appropriate exchange transaction. Further example details concerning illustrative messages presented to the POS personnel and/or the consumer will be provided below. It will be appreciated that such messages may be provided on a display screen at the POS location, on a print-out for a POS location staff member, on a customer's receipt, etc.

Whether the information is resets or carries over from the previous product may depend on the particular policies associated with the product. In accordance with certain example policies, the return/warranty information may reset so that it reflects the replacement product, e.g., if a replacement is provided in either the return or exchange periods. In accordance with certain other example policies, the return/warranty information will be maintained so that it reflects the return/warranty information for the product being exchanged in either the exchange or pro-rata periods. A number of different return/warranty policies are possible, and exemplary embodiments of the present invention may implement any or all such policies.

### Example Consumer Return Scenarios and Expected Results

The following paragraphs describe example consumer return scenarios and the related expected results. The examples presented below assume a return/warranty policy having certain specific features. Although these specific return/warranty policy features are typical of some products (including batteries), they should not be viewed as limiting on the scope of the invention. That is, as indicated above, certain exemplary embodiments may implement return/warranty policies that are different from those described herein. Although the particular return/warranty policies may be different depending on the particular embodiment implemented, the illustrative techniques of consulting an ER database in an ER system and maintaining history information may still apply.

The example policy used in this section assumes a 90-day return policy, a 1-, 2-, or 3-year replacement warranty (even exchange), and a 5-, 6-, or 9-year pro-rated warranty, depending on battery grade. This arrangement is outlined in the table that follows:

| Battery Grade | Retail Return | | Pro-rated |
|---|---|---|---|
| (high to low) | Policy | Exchange Policy | Warranty Policy |
| Max | 90 days | 3 years | 9 years |
| Plus | 90 days | 2 years | 6 years |
| Standard | 90 days | 1 year | 5 years |

According to this policy, all batteries can be returned to the store within 90-days for a full refund, provided that certain basic conditions are met (e.g., as long as the item is not damaged). Batteries may be exchanged for similar products (e.g., the same SKU), if eligible under the exchange policy. However, the time from the original purchase will continue to calculate towards a pro-rata warranty. Batteries returned during the pro-rata period will be accepted by the retailer in exchange for a discount on a future battery purchase.

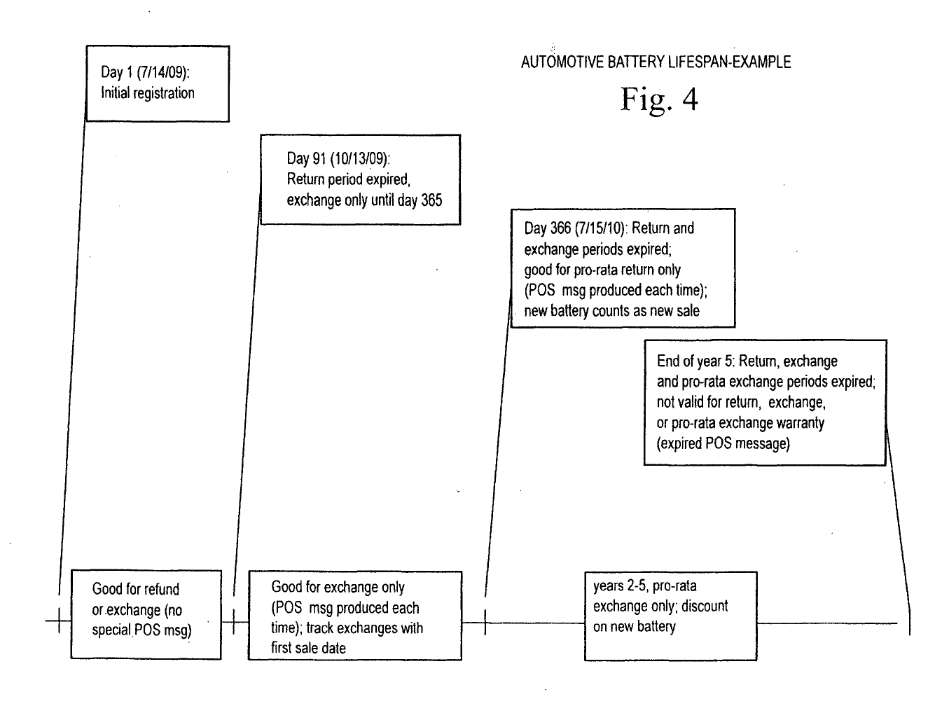

FIG. 4 is a visual timeline of an illustrative return/warranty policy in accordance with certain exemplary embodiments. The illustrative return/warranty policy shown in FIG. 4 corresponds to the “standard” policy above. Assuming a battery is purchased on Jul. 14, 2009, the 90-day return policy period will expire on Oct. 12, 2009. Thus, from Jul. 14, 2009 through Oct. 12, 2009, the consumer may receive a refund or an exchange, and no special messages will be generated upon such an event. However, between day 91 (Oct. 13, 2009) and the one year date (Jul. 14, 2010), inclusive, the consumer may only exchange the product. Even though a product received during an exchange during this period is “new” to the consumer, the first sale date of the original product may selectively apply so that the “new” product (1) can be returned within 90 days of the date the customer receives it, (2) cannot be exchanged for a further product past the original one year date (Jul. 14, 2010), and/or (3) cannot be eligible for anything other than a pro-rata exchange from Jul. 15, 2010 to the end of the five year term. From day 366 (Jul. 15, 2010) until the end of the five-year period, the consumer may only receive a pro-rata return. That is, the consumer may only receive credit towards the purchase of a replacement, with the amount of the credit being determined by the store. A purchase during the pro-rata exchange period may qualify as a completely “new” product, thus resetting the initial registration. Beyond the five year period, an expired message may be presented at the POS location.

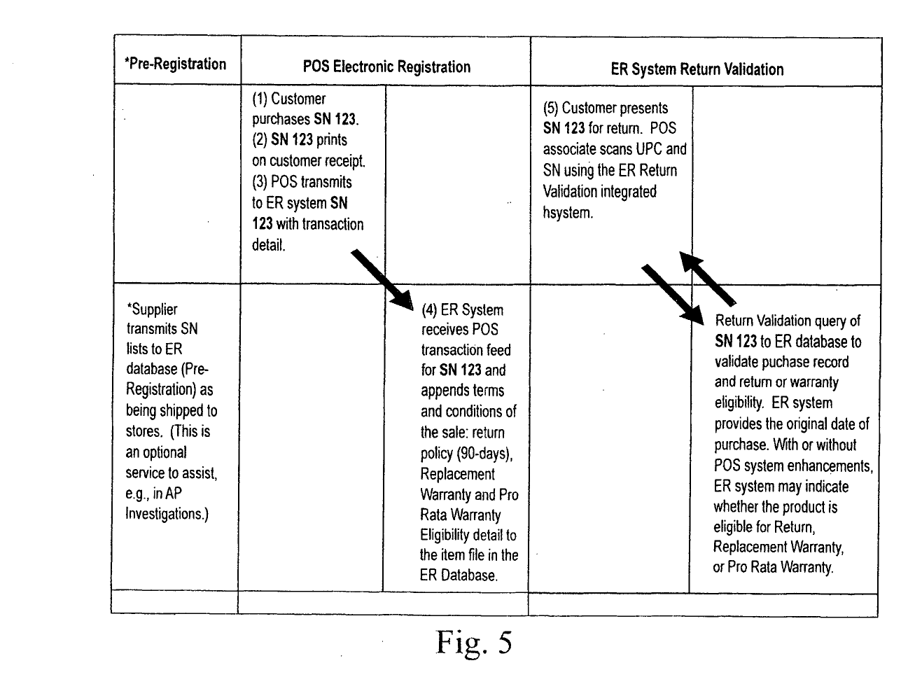

FIG. 5 is an illustrative, high-level flow for handling multiple or variable return/warranty policies in accordance with certain exemplary embodiments. In an optional pre-registration step (*), a supplier may transmit serial number lists to the ER database, so that it is clear that which serial numbers are being shipped to which stores. Other information such as, for example, the date(s) shipped also may be transmitted in this pre-registration step. It will be appreciated that this sort of information is useful, for example, in connection with enhanced reporting and asset protection measures, among others. As a customer makes a purchase of a product having serial number 123 (1), serial number 123 prints on the customer's receipt (2). The POS location transmits transaction details to the ER system (3), so that the ER system associates these transaction details with serial number 123. The transaction detail may include, for example, date and/or time of purchase, place of purchase (e.g., store number, register number, etc.), product information (such as brand name, model, etc.), return/warranty information, transaction number, etc. Alternatively or in addition, this information may be associated with the product being purchased based on, for example, pre-registration data provided by the supplier, information provided previously or at the same time by the POS location, etc.

The ER System receives the POS transaction feed for serial number 123 and appends the appropriate terms and conditions of the sale (4). For example, return policy, replacement warranty, and pro-rata warranty eligibility detail may be associated with the item file in the ER database. It is noted that the transaction detail may be transmitted for each UPC/serial number sold, returned, exchanged, re-sold, etc., in certain exemplary embodiments.

Later, when the customer presents serial number 123 for return (5), the POS associate scans the UPC, serial number, and/or other unique identifier. This information is provided to the ER return validation integrated system. A return validation query of serial number 123 against the ER database is performed to validate the purchase record and return/warranty eligibility. The ER system provides the original date of purchase. With or without POS system enhancements, the ER system may indicate whether the product is eligible for return, replacement warranty, or pro-rata exchange. To link a returned serial number with an exchange serial number, the ER system may in certain exemplary embodiments use the transaction date and timestamp.

Several example scenarios will now be presented in connection with the example policies described above so that these general techniques become yet clearer.

### Scenario 1: Retail Return Policy

In this scenario, a consumer purchases a standard grade battery, and returns it on day 80 for a refund. During this period, the product has not been damaged in any way that would make it unacceptable for return. This scenario results in a full refund (cash or in-store credit, at retailer discretion) for the consumer. In operation, the serial number is scanned at the point of return and the ER system validates the request. The register is not stopped, and the ER system processes and/or records the item return.

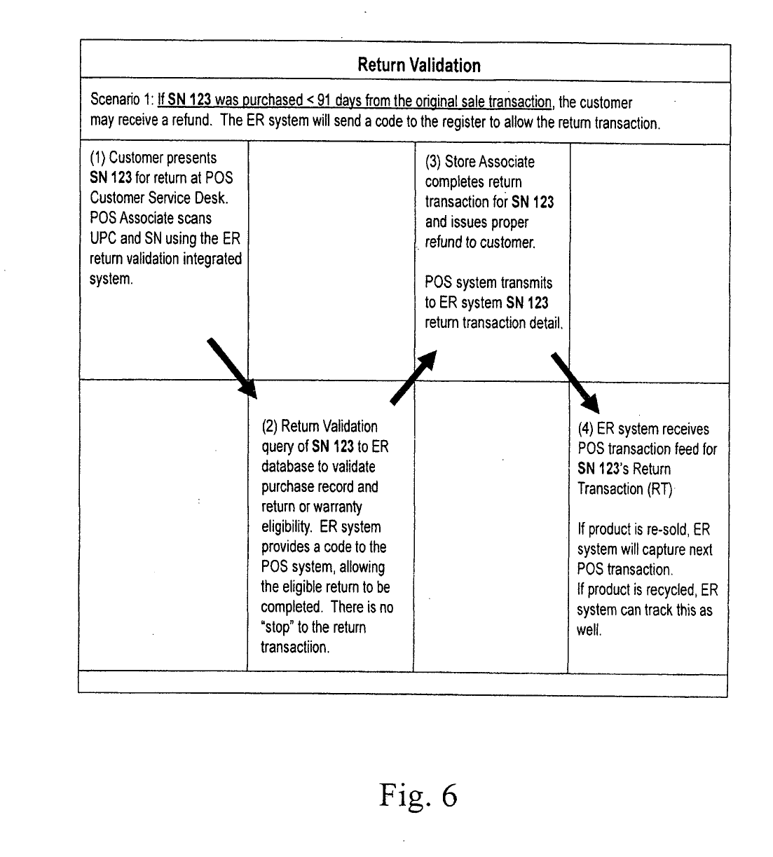

FIG. 6 is a detailed view of the return policy flow in accordance with certain exemplary embodiments. In (1), the customer presents SN 123 for return at POS Customer Service Desk. A POS Associate scans the UPC and SN using the ER return validation integrated system. In (2), a return validation query of SN 123 is sent to the ER database to validate the purchase record against return or warranty eligibility. The ER system provides a code to the POS system, allowing the eligible return to be completed. There is no “stop” to the return transaction. In (3), the store Associate completes the return transaction for SN 123 and issues the proper refund to customer. The POS system transmits to the ER system SN 123 return transaction detail. In (4), the ER system receives the POS transaction feed for SN 123's Return Transaction (RT). If the returned product is later re-sold, the ER system will capture next POS transaction. The ER system also can track recycling of the product. With this additional lifecycle information, the ER system may be able to identify and report on any discrepancies between items returned to stores and those returned to the manufacturer. Detailed reporting and analysis also may help identify specific areas of loss, while also helping to authenticate disposal responsibility.

### Scenario 2: Exchange Policy

In this scenario, a consumer purchases a plus battery and returns the battery on day 92. Although the product is not eligible for a cash refund, it is eligible for an exchange. Accordingly, the battery is exchanged, with the replacement battery retaining 638 days of exchange policy eligibility and 2098 days of pro-rata warranty eligibility. In operation, the serial number is scanned at the point of return, and the ER system validates the return. The register is halted, and an exchange message is produced for the POS associate (see the example description below). The ER system records the exchange and updates the policy of the current battery to the correct number of pro-rata days.

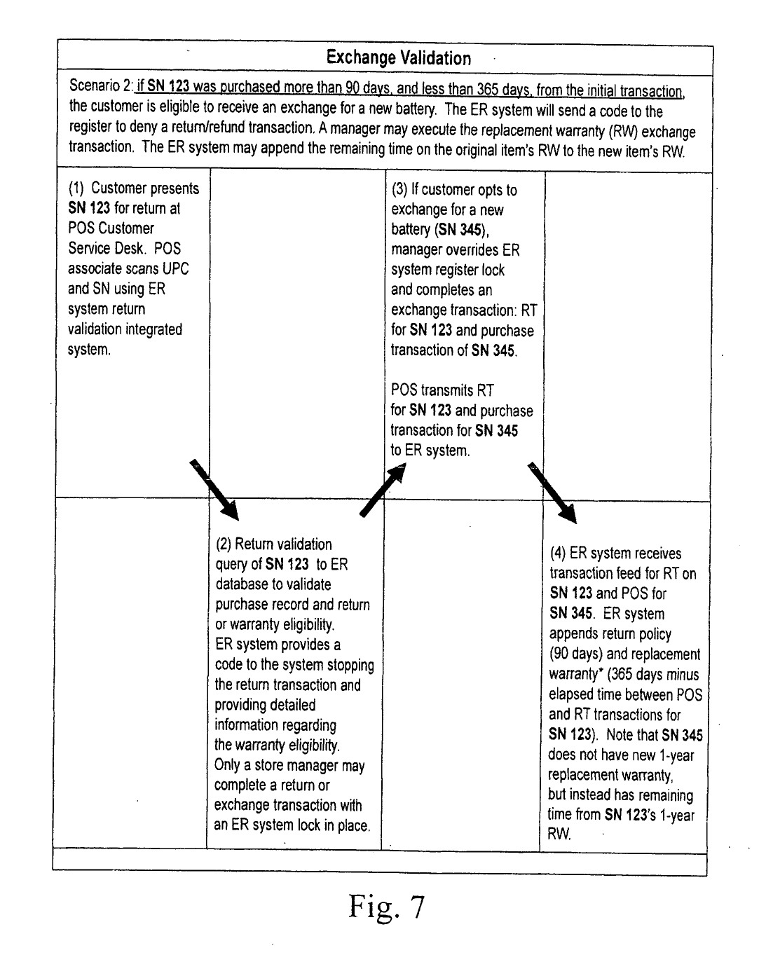

FIG. 7 is a detailed view of the exchange policy flow in accordance with certain exemplary embodiments. Similar to the FIG. 5 example flow, in (1), the customer presents SN 123 for return at POS Customer Service Desk. A POS Associate scans the UPC and SN using the ER return validation integrated system. In (2), a return validation query of SN 123 is sent to the ER database to validate the purchase record against return or warranty eligibility. The ER system provides a code to the system stopping the return transaction and providing detailed information regarding the warranty eligibility. In certain exemplary embodiments, only authorized personnel (e.g., a store manager, service desk clerk, sales associate, etc.) may complete a return or exchange transaction with an ER system lock in place. In (3), if the customer opts to exchange the existing battery for a new battery (e.g., SN 345), the manager overrides the ER system register lock and completes an exchange transaction (e.g., return transaction or RT for SN 123 and purchase transaction of SN 345). The POS transmits the return transaction for SN 123 and purchase transaction for SN 345 to the ER system. In (4), the ER system receives a transaction feed for the return transaction on SN 123 and POS for SN 345. The ER system appends the return policy (90-days) and replacement warranty (365 days minus elapsed time between POS and RT transactions for SN 123). Note that, in this example, SN 345 does not have new 1-year replacement warranty, but instead has remaining time from SN 123's 1-year replacement warranty or RW. Of course, the ER system also can support a policy for the replacement item so that it has either the “time remaining” warranty or an alternate “90-day” warranty, whichever is greater, if this policy is implemented. A store may define alternate policies, and the ER system may, in turn, support those custom policies. See, for example, co-owned and commonly assigned U.S. Publication No. 2002/0133425, the entire contents of which are hereby incorporated herein by reference.

In certain exemplary embodiments, one such custom policy may be to provide the customer with the option of choosing the return/warranty policy to be used. The policy of letting the customer choose the policy may be advantageous to the customer, for example, in that may give the customer an increased sense of control, the ability to select a product that is better suited to the customer's needs (if they were not accurately assessed at the time of the original purchase, if they have changed, etc.), if the first product turned out to be a “dud,” etc. This policy of letting the customer choose the policy also may be advantageous from the perspective of the POS location, in that it may sometimes allow for an “up-sell” (where there may be higher or better margins, etc.), to remove “duds” from circulation, etc. One example of such a policy involves enabling a customer to decide whether to receive a like-like product exchange or to receive a credit for the returned good for the purchase of a higher-grade product (e.g., an $X credit for the purchase of a Y or Z good)—even if the customer is in the first return/exchange period. In certain exemplary embodiments, a coupon, store credit, or other way of conveying value may be provided to the customer for use at the same or a later time. It will be appreciated that “down-sells” also may be allowed in certain exemplary embodiments.

In certain exemplary embodiments, it may be possible to return or exchange products to a POS location that are not sold by that POS location. For example, some POS locations recycle certain products (e.g., as the case with some POS locations and automotive batteries), even though they do not sell them. Certain exemplary embodiments thus may convey any residual value of the product to the customer. The ER database may find the relevant information regarding the product such as, for example, original sale date, original price, applicable return/warranty policy and terms and/or conditions thereof, etc. (e.g., after the product has been scanned or otherwise identified). In such cases, a customer seeking to return a product may receive a coupon, store credit, or other form of value. The customer may then engage in a return, exchange, or pro-rata exchange for a particular product that is sold at the POS location. It will be appreciated that this sort of processing advantageously allows for cross-store sales and return possibilities.

### Scenario 3: Pro-Rata Policy

In this scenario, a consumer purchases a “max” battery and returns it on day 1096 (one day after exchange warranty expiration). Although the product is not eligible for cash refund or exchange, the battery is accepted by the retailer in accordance with a pro-rata program. In this regard, the retailer may enter the original purchase date to calculate the discount to be applied for the next battery purchase. The discount may be processed in the same or a different system from the ER system and/or the POS system in certain exemplary embodiments. Furthermore, in certain exemplary embodiments, the POS location may define the specific pro-rata policy. If the battery had been exchanged previously, the original purchase date may be set to the purchase of the first battery purchased.

In operation, the serial number is scanned at the point of return, and the ER system validates the return. The register is halted, and an appropriate message is produced for the POS associate (see the example description below), e.g., so that the POS associate is prompted to enter the original date of purchase for the first battery. Alternatively, or in addition, the information may be automatically retrieved from the ER database, thereby causing the process to advance to the next step after the ER system returns the appropriate data. This date may be used in subsequent pro-rata steps at the POS. The ER system may receive information regarding the next battery if it is purchased at the same time or otherwise identified (e.g., via coupon redemption or the like) in certain exemplary embodiments. In certain exemplary embodiments, the entire process may be reset, with new exchange and pro-rata periods being set.

### Scenario 4: Expiration

In this scenario, a consumer purchases a “max” battery and returns it on day on day 10,000, which is after the expiration of pro-rata period. The product is not eligible for cash refund, exchange, or pro-rata credit. In operation, the serial number is scanned at the point of return, and the ER system validates the return. The register is halted, and an appropriate message is produced for the POS associate (see the example description below), e.g., so that the POS associate is prompted to enter the original date of purchase for the first battery if it is not automatically retrieved from the ER database. Based on a comparison of this date to the policy terms, it is determined that the product is ineligible for return, and an appropriate message to this effect is produced.

### Example Messaging

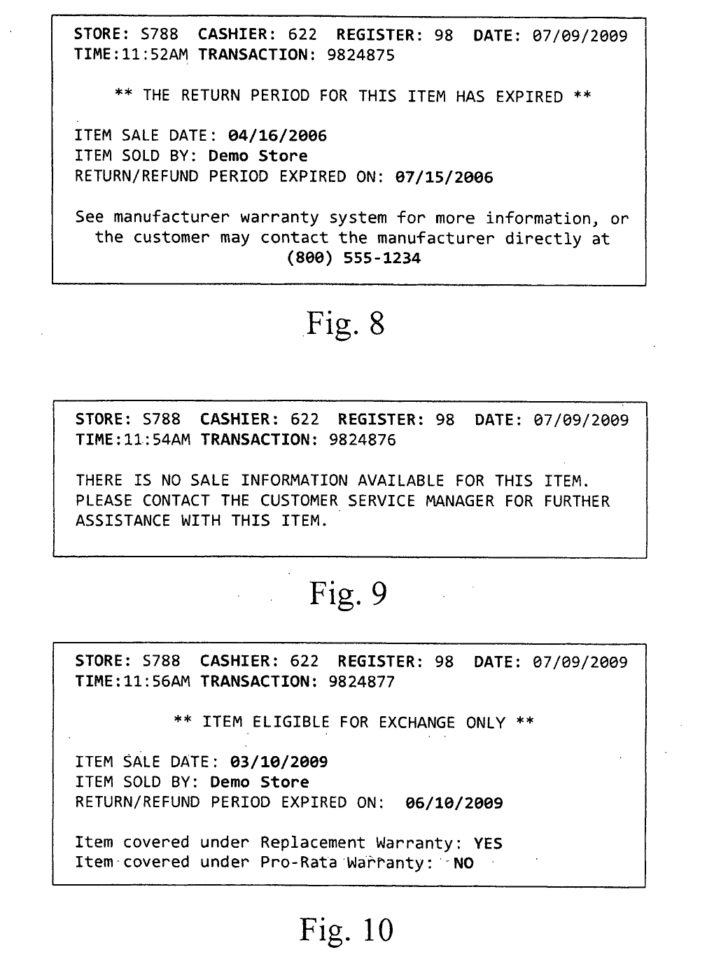

Certain exemplary embodiments may provide messages to a POS associate attempting to process a product return/warranty request. These messages may be generated by the ER system and transmitted to the POS location, e.g., over a network connection. In this regard, current messaging protocols and/or patterns may be used, or these messaging protocols and/or patterns may be modified, e.g., so that more or less information is provided. FIGS. 8-14, described in detail below, show example messaging patterns for various scenarios, in accordance with certain exemplary embodiments.

FIG. 8 is an illustrate message indicating that a product being returned is within the replacement warranty period, in accordance with certain exemplary embodiments. Because the item is outside of the 90-day return/refund policy, it is not eligible for a refund transaction. The system stops the return transaction and provides a message that confirms the date of purchase and the date that the 90-day return period expired, indicating the initial transaction date and the end of the 90-day return period. However, the presence of the “Y” next to the “product covered under mfg. warranty” text indicates that the item is within the 1-, 2- or 3-year applicable replacement warranty.

FIG. 9 is an illustrate message indicating that a purchase record could not be found, in accordance with certain exemplary embodiments. A message such as the one shown in FIG. 9 may be provided, for example, in the event that the item was purchased before ER system was implemented for the product, the item was purchased at a location that does not provide an indication of the appropriate data such as, for example, another retailer that does not participate in the same (or any compatible) ER system, the item was stolen, etc.

Some current messages are produced only in the cases of a denied return/refund such as, for example, in connection with an out-of-policy, cross-retailer, or not registered (POS record not found), event. However, in certain exemplary embodiments, the ER system may be configured to provide messaging explaining why the return was denied. It will be appreciated that it would be advantageous to provide this detail to the POS location, e.g., so that the associate may provide better or more complete service and/or so that the customer is adequately and accurately informed of the reason(s) behind the denial—and any other possible remedies.

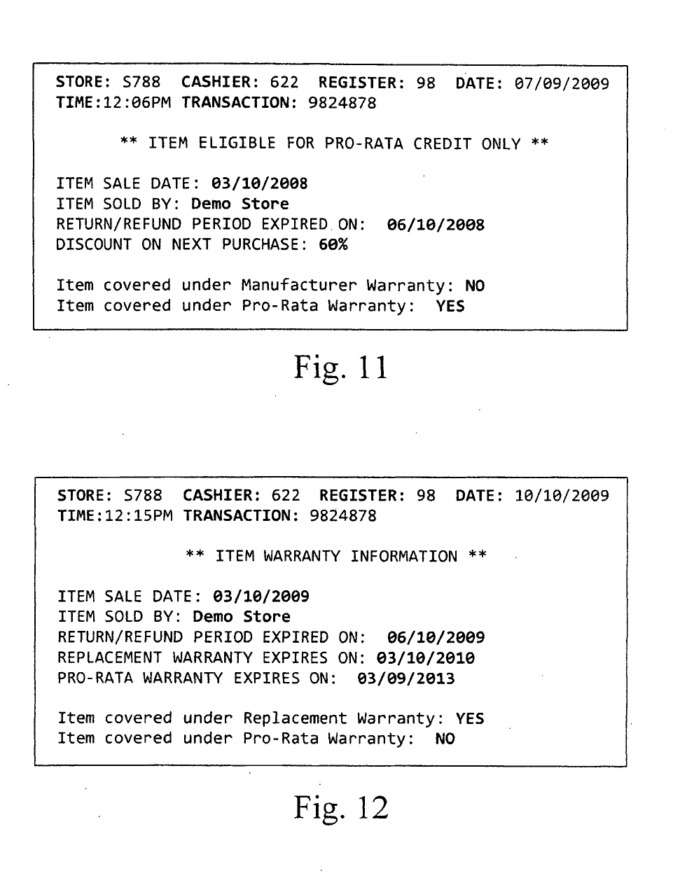

Accordingly, certain exemplary embodiments may replace the text in one or more existing fields to provide a more complete indication as to what is going on with the attempted return/warranty request. For example, in certain exemplary embodiments, the name of the location where the item was stored may include enough physical space to provide an indication as to what is going on with the attempted return/warranty request. For example, FIGS. 10 and 11 are messages indicating that the item presented for the return/warranty request only quality for replacement and pro-rata exchange, respectively, in accordance with certain exemplary embodiments.

In certain exemplary embodiments, it may be possible to provide messaging that more clearly states the updated warranty for the replacement item, as it will differ from a new item warranty, e.g., in text such as “Replacement Warranty Expires on: [DATE].” FIG. 12 is an illustrative message including detail on all phases of the return/warranty program, in accordance with certain exemplary embodiments. The particular FIG. 12 example illustrates that the item being returned is outside of the 90-day return/refund policy and is not eligible for a refund transaction. The expiration dates for the replacement and pro-rata exchange portions of the return/warranty policy are provided in the message.

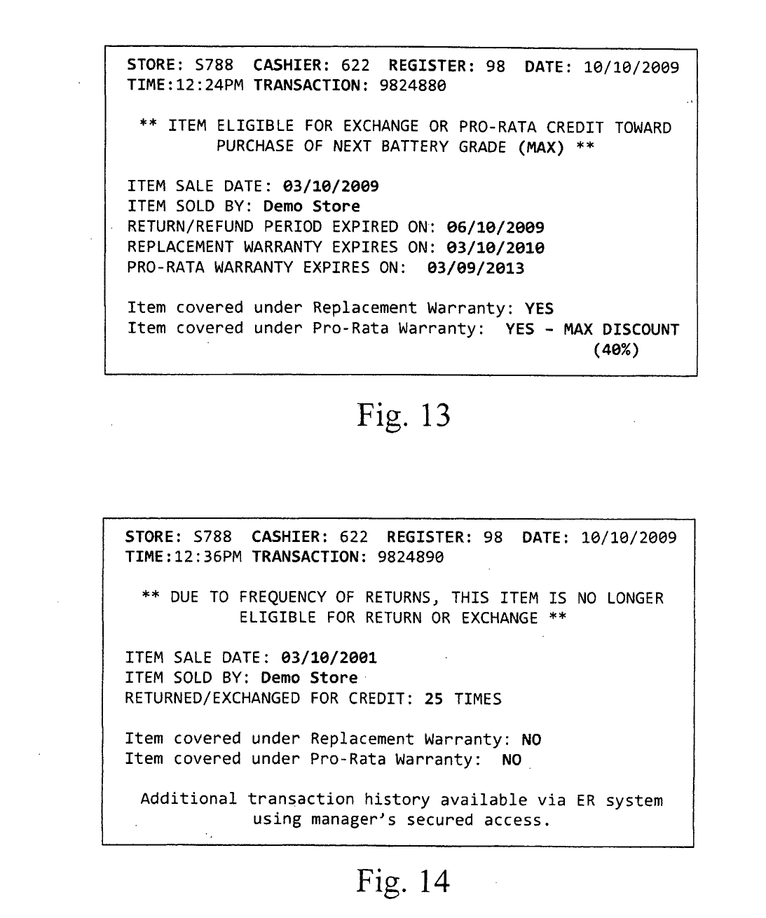

FIG. 13 is an illustrative message indicating that a product qualifies for one of several return/warranty policies and provides a specific value for a pro-rata exchange, in accordance with certain exemplary embodiments. This sort of message may be provided in connection with an exemplary embodiment that lets customers choose the particular aspect of a return/warranty policy that should be used when multiple are possible. A vast amount of information is provided including, for example, specific dates at which each policy expired or will expire, an amount of credit available under a pro-rata exchange, etc. In certain exemplary embodiments, the message may be presented on a receipt for the customer and, in the event that the customer decides to make a pro-rata exchange, the value indicated thereon may be honored at the same or a later time. In certain other exemplary embodiments, the message may be provided on a display screen of a POS location, thereby prompting authorized personnel to deduct an appropriate amount of money when a pro-rata exchange is made. Of course, it will be appreciated that the various aspects of the message may be provided together or separately in different exemplary embodiments of this invention. As one example, indicating the value for a pro-rata exchange may be provided together with or apart from situations where a customer has the ability to decide which aspect of the return/warranty policy is to be used, and vice versa.

As alluded to above, in certain exemplary embodiments, the ER system may maintain a history of product returns and/or exchanges, e.g., in an ER database. The ER system thus may track the number of returns and/or exchanges over the lifetime of a particular policy. This and/or other sorts of information may be useful for a variety of purposes including, for example, identifying more or less troublesome products, customers, lots, locations, etc. As one example, when the number of returns and/or exchange for a particular policy lifetime exceeds a predetermined threshold (e.g., 5, 10, 25, or any selected number), the ER system may indicate that a problem is likely. In such a situation, the current return or exchange request may be denied and/or the register may be locked. In this regard, FIG. 14 is an illustrative message for a product that has been flagged as being returned and/or exchanged too many times, in accordance with certain exemplary embodiments. The FIG. 14 example message indicates that 25 different returns and/or exchanges had been made over the lifetime of the relevant policy, thus triggering a denial of the current request. In certain exemplary embodiments, detailed transaction history may be provided from the ER system (e.g., with a store manager's access) including, for example, dates, times, locations, and/or other details of the various returns/exchanges. It will be appreciated that this information may be maintained in and provided from the ER database of the ER system. The message may also include further details for the customer in certain exemplary embodiments, e.g., pertaining to how to obtain further information as to why the particular transaction has been stopped.

In view of the above, it will be appreciated that the techniques described herein may result in a number of advantages. Such advantages may relate to, for example, the ability to track products by serial number to systematize the return and exchange processes within the POS system, provide consumers with automated warranty and return validation processes to speed the return or exchange transaction, as well as assist in cases of lost receipts, limit and track replacement warranties (e.g., 1-, 2- and 3-year replacement warranties) to the date of sale for the original battery purchase regardless of the number of exchanges made, limit and track pro-rata warranties (e.g., 5-, 6- and 9-year pro rata warranties) to the date of sale for the original battery purchase regardless of the number of exchanges made, provide POS location and product suppliers with detailed monthly reporting of category transaction activity (including, for example, re-sales, exchange rates, and aging between item transactions), support item level research and exception reporting (e.g., via the electronic purchase records), track recycling and disposal percentages for core recovery compliance and sustainability, etc. Further advantages may relate to, for example, the abilities to base decisions (replacement, pro-rata, etc.) based on the original sale date of unique battery, automate and systematize decision-making, monitor compliance to appropriate retailer return policies, test changes in the return policy (e.g., by state or UPC, etc.), etc.

Although certain exemplary embodiments have been described in relation to batteries and battery return/warranty programs, it will be appreciated that the exemplary techniques described herein may be applied to other kinds of products, or even goods and services. In general, the exemplary techniques described herein may be applied to any serialized item that may have an associated variable return/warranty policy associated with it. For example, the techniques of certain exemplary embodiments may be applied to consumer electronics products such as, for example, computers, televisions, digital cameras, and/or the like. In general, the techniques of certain exemplary embodiments may be applied to anything that has at least some residual value after it is returned or exchanged. Furthermore, although certain exemplary embodiments have been described in relation to return/warranty policies having three different periods, it will be appreciated that the techniques described herein may be applied to any variable return/warranty policy having, for example, two or more different time periods corresponding to two or more different terms and/or conditions.

Although certain exemplary embodiments described herein have shown and/or described messages being provided on displays, receipt tapes, and/or the like, it will be appreciated that such messages may be provided in different ways, in different formats, and/or on different media. For example, such messages may be provided on a display screen at the POS location for the customer and/or staff member, on a print-out for a POS location staff member, on a customer's receipt, etc. Additionally, although certain exemplary embodiments have been described as relating to serial numbers, it will be appreciated that the techniques described herein may be applied to products identified in different ways, e.g., by EPC, RFID, EAN, JAN, etc.

Additionally, although certain exemplary embodiments have been described in relation to products having serial numbers, the present invention is not so limited. For example, unserialized products may also take advantage of the techniques described herein by virtue of other unique and/or identifiable characteristics thereof. Furthermore, certain products are produced in such limited quantities that their mere existence may be self-authenticating and/or self-identifiable. Additionally, certain products are so tightly controlled that their appearance via other channels may indicate a potential problem worthy of notification to a trusted authority (e.g. the auction house, a manufacturer, a trusted ER intermediary, etc.).

While the systems and methods have been described in connection with what is presently considered to practical and preferred embodiments, it is to be understood that these systems and methods are not limited to the disclosed embodiments, but on the contrary, is intended to cover various modifications and equivalent arrangements included within the scope of the appended claims.

What is claimed is:

1. A method of processing a product at a point-of-sale (POS) location, the method comprising:
identifying the product at the POS location;
retrieving return/warranty information from an electronic registration (ER) database, the return/warranty information indicating a first time period during which a refund is acceptable, a second time period during which product replacement is acceptable, and a third time period during which pro-rata product exchange is acceptable;
determining whether the processing is taking place during the first, second, or third time period;
when the processing is taking place during the first time period, providing the refund or a replacement product;
when the processing is taking place during the second time period, providing a replacement product;
when the processing is taking place during the third time period, providing an amount of credit for the subsequent purchase of a replacement product, the amount of credit being relative to when the processing is taking place in the third time period;
when the processing is taking place beyond the third time period, denying any return/warranty request;
updating the ER database to reflect a refund, replacement product, or pro-rata exchange; and
when a replacement product is provided, associating, in the ER database, at least some information pertaining to the product with the replacement product.

2. The method of claim 1, wherein the associating further comprises:
updating the ER database such that a second time period for the replacement product is the same as the second time period for the product and a third time period for the replacement product is the same as the third time period for the product.

3. The method of claim 2, wherein the associating further comprises:
updating the ER database such that a first time period for the replacement product is generated anew and does not correspond to the first time period for the product.

4. The method of claim 1, wherein the ER database is located in an ER system remote from the POS location.

5. The method of claim 1, wherein when the processing is taking place during the second or third time period, temporarily halting the processing at the POS location by freezing a computer used in the processing until an authorized person at the POS location authorizes the processing to continue.

6. The method of claim 1, further comprising providing a message to the POS location indicating when the first, second, and/or third time periods expired or will expire.

7. The method of claim 1, further comprising providing a message to the POS location including an indication of the time period during the processing is taking place.

8. The method of claim 1, further comprising providing a message to the POS location including an indication of currently applicable return/warranty policy terms or conditions.

9. The method of claim 8, wherein the indication is provided in a location otherwise reserved for place of purchase information.

10. The method of claim 1, wherein the product is a battery.

11. A method of managing an electronic registration (ER) system including an ER database, the method comprising:
populating the ER database with information corresponding to a plurality of products;
updating the ER database as products are sold, the ER database including a unique identifier for the product and an original transaction date corresponding to the sale;
identifying an already-purchased product presented for return or exchange at a point-of-sale (POS) location;
determining terms and/or conditions for the return or exchange based on the original transaction date stored in the ER database and associated with the product;
providing a refund or replacement product when doing so is acceptable within the terms and/or conditions; and
when a replacement product is provided, updating the ER database so that an original transaction date for the replacement product corresponds to the original transaction date for the already-purchased product for at least some of the terms and/or conditions.

12. The method of claim 11, wherein the terms and/or conditions specify a first time period during which a refund is acceptable, a second time period during which product replacement is acceptable, and a third time period during which pro-rata product exchange is acceptable.

13. The method of claim 12, wherein the terms and/or conditions further specify an amount of credit for the subsequent purchase of a replacement product, the amount of credit being relative to when the processing is taking place in the third time period.

14. The method of claim 12, wherein the ER database is updated so that the original transaction date for the replacement product corresponds to the original transaction date for the already-purchased product for the second time period.

15. The method of claim 12, wherein the ER database is updated so that the original transaction date for the replacement product corresponds to the original transaction date for the already-purchased product for the third time period.

16. The method of claim 12, wherein the ER database is updated so that the original transaction date for the replacement product corresponds to the original transaction date for the already-purchased product for the second and third time periods.

17. An electronic registration (ER) system, comprising:
an ER database including information corresponding to a plurality of products, the ER database being updated by the ER system as products are sold to reflect an original transaction date corresponding to the sale; and
a return validation subsystem configured to:
identify an already-purchased product presented for return or exchange at a point-of-sale (POS) location;
determine terms and/or conditions for the return or exchange based on the original transaction date stored in the ER database and associated with the product;
send a message to the POS location authorizing a refund or replacement product to be provided when doing so is acceptable within the terms and/or conditions; and
when a replacement product is provided, update the ER database so that an original transaction date for the replacement product corresponds to the original transaction date for the already-purchased product for at least some of the terms and/or conditions.

18. The system of claim 17, wherein the terms and/or conditions specify a first time period during which a refund is acceptable, a second time period during which product replacement is acceptable, and a third time period during which pro-rata product exchange is acceptable.

19. The system of claim 18, wherein the ER database is updated so that the original transaction date for the replacement product corresponds to the original transaction date for the already-purchased product for the second time period.

20. The system of claim 18, wherein the ER database is updated so that the original transaction date for the replacement product corresponds to the original transaction date for the already-purchased product for the third time period.

21. The system of claim 18, wherein the ER database is updated so that the original transaction date for the replacement product corresponds to the original transaction date for the already-purchased product for the second and third time periods.
